(19) United States
(12) Patent Application Publication
(10) Pub. No.: US 2011/0223351 A1
(43) Pub. Date: Sep. 15, 2011

(54) LASER CLADDING OF A THERMOPLASTIC POWDER ON PLASTICS

(75) Inventors: Bert Verheyde, Hasselt (BE); Marleen Rombouts, Ham (BE); Annick Vanhulsel, Begijnendijk (BE); Robby Rego, Geel (BE); Filip Motmans, Alken (BE)

(73) Assignee: Vlaamse Instelling VoorTechnologisch Onderzoek N.V. (VITO), Mol (BE)

(21) Appl. No.: 13/119,691

(22) PCT Filed: Oct. 15, 2009
(86) PCT No.: PCT/EP2009/063505

§ 371 Date: May 23, 2011

(30) Foreign Application Priority Data
Oct. 15, 2008 (EP) 08166722.2

(51) Int. Cl. B05D 7/02; B05D 3/10; B05D 3/06

(52) U.S. Cl. 427/535; 427/554

(57) ABSTRACT

A method applies a coating (17) of a thermoplastic material on a substrate (11) made of a polymeric material, with the thermoplastic material and the polymeric material being incompatible. Firstly, the substrate and/or the powder are exposed to a plasma discharge (12) or the reactive gas stream resulting therefrom in order to obtain a plasma treated surface layer (14) introducing compatibility at the interface between substrate and coating. Secondly, laser cladding (15) the powder (16) on the substrate is conducted in order to form a coating on the substrate.

The present invention is related to methods of applying a coating on the surface of a polymeric material by laser cladding a thermoplastic powder on said surface. In particular, where said plastic material and said thermoplastic powder are mutually incompatible plastics.

Laser cladding is a well known technique for applying metal based coatings on metal substrates. It is used as a repair technique and/or to increase the corrosion and wear resistance of the component. The process can also be used for applying polymer coatings, as is known from e.g. patent application WO 2007/009197. Briefly, a coating of a thermoplastic material can be applied on a substrate by heating the substrate, in particular by laser radiation (e.g. scanning a laser beam over the substrate), and simultaneously supplying a powder of said thermoplastic material on the heated substrate. As the powder absorbs part of the laser energy, the applied thermoplastic powder melts and thereby forms a coating. That coating can be densified by further heating the coating, in particular by exposing the coating (coated surface) to laser radiation (e.g. by scanning the laser beam a second time over the coated substrate).

However, in the case that the substrate and the powder are both made of incompatible plastics, the applied coating will show weak adherence to the substrate. Such coatings are not recommended in practical applications.

In order to ensure a good adhesion, the materials of substrate and coating should entangle at the interface, so that polymer chains of the different materials interlock each other at the interface. However, there exist plastic materials which will not or insufficiently entangle during cladding, resulting in none or a very poor adhesion. Such materials are referred to as incompatible plastic materials or incompatible plastics.

Incompatible plastics refer to plastics that show neither mutual chemical, nor mutual physical affinity towards bonding and/or entanglement. Incompatible plastics can be dissimilar plastics (plastics having different chemical structures). However, not all dissimilar plastics are necessarily incompatible. Incompatibility is likely between polymers with high differences in melting points or glass transition temperatures, or between amorphous and semi-crystalline polymers.

There is hence a need in the art of an improved method of laser cladding, enabling or increasing the adherence or bonding of a thermoplastic coating on a polymeric substrate material, which overcomes the drawbacks of the prior art. In particular, it is an aim of the invention to provide such methods, wherein the said polymeric substrate and thermoplastic coating are originally mutually incompatible materials towards bonding and/or entanglement and which nevertheless result in a good adhesion and/or bonding.

It is an aim of the invention to provide methods of laser cladding, wherein the bonding strength is superior over the results obtained in the art.

Aims of the invention are met by providing methods of applying a coating of a thermoplastic material on a substrate made of a polymeric material, as set out in the appended claims.

According to a first aspect of the invention, there is provided a method of applying a coating of a thermoplastic material on a substrate made of a polymeric material, wherein said thermoplastic material and said polymeric material are incompatible, comprising the following steps. Firstly, exposing the substrate to a first plasma discharge or the reactive gas stream resulting therefrom to obtain a plasma treated substrate. The substrate is exposed at least at a surface thereof, said surface constituting the interface with the coating. Secondly, scanning a laser beam along a line on (the exposed surface of) said plasma treated substrate in order to heat up the plasma treated substrate. Thirdly, supplying a powder of said thermoplastic material on said line in order to form a coating on the plasma treated substrate. Steps of the invention can be carried out simultaneously.

According to a second aspect of the invention, there is provided a method of applying a coating of a thermoplastic material on a substrate made of a polymeric material, wherein said thermoplastic material and said polymeric material are incompatible, comprising the following steps. Firstly, exposing a powder of said thermoplastic material to a second plasma discharge or the reactive gas stream resulting therefrom to obtain a plasma treated powder. Secondly, scanning a laser beam along a line on the substrate in order to heat up the substrate. Thirdly, supplying said plasma treated powder on said line in order to form a coating on the substrate. Steps of the invention can be carried out simultaneously.

Steps of scanning a laser beam on the substrate and of supplying a powder in order to form a coating as identified in the above aspects refer to the application of a coating by laser cladding.

According to another aspect of the present invention, methods according to the first aspect and methods according to the second aspect are combined.

Methods of the invention can comprise selecting a plasma forming gas so as to introduce compatibility at the interface between the substrate and the coating. Hence, a plasma forming gas is preferably selected for the first plasma discharge so as to obtain a chemical group in a surface layer of the substrate that is compatible with the thermoplastic material. A plasma forming gas is preferably selected for the second plasma discharge so as to obtain a chemical group in a surface layer of the thermoplastic material that is compatible with the polymeric material of the substrate.

Preferably, the first plasma discharge is formed with a plasma forming gas selected from the group consisting of: air, N₂, O₂, CO₂, H₂, N₂O, He, Ar and mixtures thereof. The second plasma discharge is preferably formed with a plasma forming gas selected from the same group.

Preferably, in the step of exposing the substrate and/or in the step of exposing the powder, the exposed surface of the exposed material is heated at least temporarily to at least the glass transition temperature thereof, preferably to at least the melting temperature thereof.

Methods of the invention can advantageously comprise the step of introducing a first precursor into the first plasma discharge, or into the reactive gas stream resulting therefrom prior to the exposing step.

Methods of the invention can advantageously comprise the step of introducing a second precursor into the second plasma discharge, or into the reactive gas stream resulting therefrom prior to the exposing step.

Preferably, the first and the second precursors are the same.

The first precursor and/or the second precursor can be so selected as to introduce compatibility at the interface between the substrate and the coating. Hence, the first precursor is preferably selected so as to obtain a chemical group in a surface layer of the substrate that is compatible with the thermoplastic material. The second precursor is preferably selected so as to obtain a chemical group in a surface layer of the thermoplastic material that is compatible with the polymeric material of the substrate.

The first and/or second precursor is preferably allylamine. Alternatively, the precursor is preferably hydroxyl ethylacrylate. The precursor can alternatively be acrylic acid.

The first and/or second precursor is preferably methane. Alternatively, the precursor can be propane. The precursor can alternatively be ethylene. The precursor can alternatively be acetylene.

The first and/or second precursor can be water. It can alternatively be aminopropyltriethoxysilane.

Preferably, in the exposing step a chemical group is formed at least on the exposed material (and more preferably also into said material).

Said chemical group is preferably selected from the group consisting of: amine and amide groups, and more preferably imide groups as well.

Said chemical group is preferably selected from the group consisting of: carboxyl, hydroxyl and amide groups and is more preferably a hydroxyl group.

Said chemical group is preferably selected from the group consisting of: carboxyl, amine, hydroxyl, amide, imide, nitrile, di-imide, isocyanide, carbonate, carbonyl, peroxide, hydro peroxide, imine, azide, ether and ester groups.

Said chemical group is preferably a siloxane group, or a halogen group.

Preferably, in the exposing step, a surface layer (either of the substrate, or of the powder particles, or both) is affected by the plasma having a thickness falling in the range between 1 Angstrom and 1000 nm, preferably in the range between 3 Angstrom and 500 nm, more preferably in the range between 5 Angstrom and 300 nm.

Preferably, methods of the invention further comprise the step of scanning a laser beam along a line on the coating (for densifying the coating).

Preferably, said polymeric material (of the substrate) is a thermoplastic material.

Preferably, said polymeric material (of the substrate) is a thermosetting material.

### BRIEF DESCRIPTION OF THE DRAWINGS

FIG. 1 (A-D) represents method steps according to an embodiment of the invention. FIG. 1A represents a step wherein a substrate material is treated with a plasma using a plasma jet. The plasma treated substrate material is represented in FIG. 1B. FIG. 1C represents a step of coating the plasma treated substrate with a thermoplastic powder by laser cladding. FIG. 1D represents the final coated substrate.

### DETAILED DESCRIPTION OF THE INVENTION

The present invention will now be described in detail with reference to the attached figures, which are deemed to limit the scope of the present invention.

It is to be noticed that the term “comprising” should not be interpreted as being restricted to the elements listed thereafter. It does not exclude other elements or steps.

Aspects of the invention relate to methods of applying a coating of a thermoplastic material on a substrate made of a polymeric material by laser cladding. The thermoplastic material is provided in powder form as indicated above. The substrate is in particular a plastic material. Methods of the invention are particularly suited in cases wherein the coating material and the substrate material are incompatible.

In describing the present invention, the terms “plastics”, “plastic materials” and “polymeric materials” are meant to refer to the same materials and are therefore used interchangeably.

Incompatible plastics refer to plastics that do neither show mutual chemical, nor mutual physical affinity towards bonding and/or entanglement. As a result, during coating (laser cladding), no or only very weak bonds and/or entanglements are formed and the adhesion between coating and substrate is insufficient for practical applications. Most dissimilar plastics are incompatible.

According to the invention, at least one material (either the substrate material, or the powder material, or even both) is treated at least at a surface thereof by a plasma, prior to the coating stage.

The exposure to the plasma is so selected that it advantageously results in a functional surface layer that is formed at/on the surface. Chemical functional groups are thereby advantageously applied or grafted on the surface of the polymeric material and possibly into the depth of the material.

The expression “functional surface layer” or “functionalised zone” refers to the plasma treated surface area and possibly to the underlying depth that becomes affected by the said plasma treatment, i.e. it refers to a volume or surface layer.

The functional surface layer advantageously comprises functional groups. Functional groups refer to chemical groups present in the functionalised zone, upon plasma treatment of said zone, which enhance and/or introduce chemical and/or physical affinity towards bonding to one or more predetermined plastic materials. These functional groups may be provided by the plasma-forming gas and/or by suitable precursors added to that gas as indicated below.

Hence, a functional surface layer is introduced, which surprisingly enhances the compatibility of the materials during the laser cladding process.

Plasma treatment can hence be so selected that a laser cladded coating is obtained with a strong bonding, due to a plasma treated surface layer that is compatible with the other polymeric material.

The polymeric substrate material is preferably a thermoplastic material. However, it was surprisingly found that the invention also allows the laser cladding on a thermosetting substrate material.

Either the powder of thermoplastic material, the plastic substrate material, or both may be treated with a plasma for creating a functional surface layer.

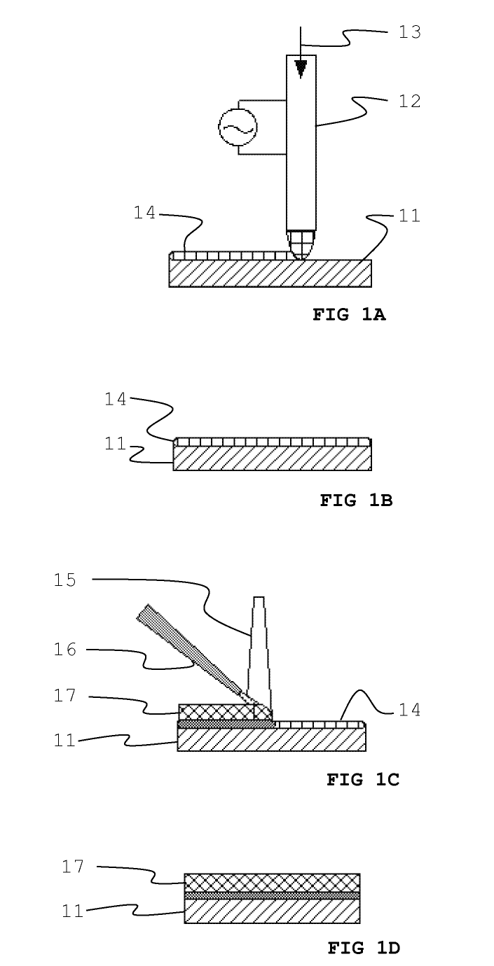

Referring to FIG. 1 A, methods of the invention hence comprise a step wherein a plasma is provided. The plasma may be a plasma discharge. Alternatively, it may be a plasma afterglow (plasma jet).

The plasma is formed with a gas 13, such as N₂, air, O₂, CO₂, N₂O, He, Ar, or a mixture thereof. Most commonly used are air and nitrogen. A plasma may be formed by techniques known in the art, such as dielectric barrier discharge, radio frequencies (RF), microwave glow discharge, or pulsed discharge. In particular, a plasma jet apparatus 12 can be used. Alternatively, a plasma discharge apparatus can be used.

The plasma forming gas may be selected depending on the polymeric material (thermoplastic powder material and/or polymeric substrate material), such that treatment of the polymeric material with the plasma formed by said gas results in a (functional) surface layer that is compatible with the other polymeric material, such as due to the formation of chemical (functional) groups. Hence, the functional (chemical) groups may originate from the plasma forming gas.

The plasma is preferably an atmospheric pressure plasma. Depending on the application, an intermediate pressure (0.1 bar to 1 bar) instead of an atmospheric pressure can be preferred for forming (discharging) the plasma.

A precursor may be introduced into the plasma discharge, or the reactive gas resulting therefrom (the plasma afterglow) in order to create a functional surface layer. The precursor may be added in the form of a gas or an aerosol. It is activated by the plasma energy. The precursor is advantageously added for creating the functional (chemical) groups.

The precursor is a chemical compound or molecule comprising advantageously one or more selected functional (or chemical) groups, for enhancing (surface) compatibility of the polymeric materials. Alternatively, reaction of the precursor with the plasma and/or with the polymeric material under influence of the plasma may result in the formation of such functional (or chemical) groups. The functional (chemical) groups can be present on/at the surface of the polymeric material subjected to plasma treatment and possibly underneath the surface, hence penetrating in the polymeric material.

Depending on the combination of polymeric material and the plasma, the formation of predetermined functional groups for enhancing compatibility may or may not require the use of precursors.

Said functional chemical group(s), enhancing and/or introducing compatibility at the interface between the coating and the substrate (or between surfaces of the polymeric substrate material and of the powder material) may be selected from the non exhaustive list of: carboxylic, amino, hydroxyl, amide, imide, imine, nitrile, carbonyl, isocyanide, azide, peroxide, hydroperoxide, ether, di-imide, carbonate and ester groups. The chemical group can be a halogen containing group. It can alternatively be a siloxane group as well (for e.g. silicones).

It is to be noted that for a predetermined combination of plastic materials, different functional groups may achieve a same enhancement in bonding properties. Hence, in methods of the present invention, for a given combination of thermoplastic powder material and polymeric substrate material, different plasma treatments may be possible to achieve a same effect.

Precursors such as allylamine, hydroxyl ethylacrylate and acrylic acid may provide particular chemical groups. Typically, with an allylamine precursor, amide and/or amine groups may be deposited. Acrylic acid precursors may lead to the deposition of hydroxyl, carboxyl and/or amide groups. With hydroxyl ethylacrylate precursors, one may find hydroxyl groups deposited.

In many cases, hybrid organic/inorganic precursors can be used in order to introduce a compatibility. For example, aminopropyltriethoxysilane as precursor in a plasma gas introduces amino groups on the surface of the material treated with the plasma.

The plasma forming gas can itself introduce functional groups, without the need of precursors. Nitrogen gas typically may introduce functional groups such as amide, amine and imide. Adding certain amounts of hydrogen or N₂O may typically change the relative contribution of the afore-mentioned introduced functional groups. Using oxygen as plasma-forming gas will usually result in the introduction of functional groups such as hydroxyl, carboxylic acid, peroxide, ketone and aldehydes.

By way of example, by introducing a functional surface layer comprising amine, imide, or amide groups on the polymeric substrate, a polyamide (PA) coating can be applied by laser cladding on the polymeric substrate. Such groups can be introduced by treating the substrate with a plasma formed with nitrogen gas, or with a plasma formed with a mixture of nitrogen gas and CO₂, H₂, or N₂O. For obtaining the same effect, the polymeric substrate can be treated with a plasma gas in which one or more of the following precursors are introduced: an organic chemical with amino groups (e.g. allylamine), with amide groups, or with imide groups, or an organic precursor such as methane, propane, ethylene, or acetylene. By so doing, compatibility with the amide groups of the PA powder can be obtained.

In another example, by introducing a surface layer comprising amine groups on the polymeric substrate, a polyurethane (PU) coating can be applied on that polymeric substrate by laser cladding. The amine group can be introduced by treating the substrate with a plasma formed with air, or CO₂. For obtaining the same effect, the polymeric substrate can be treated as well with a plasma gas in which one or more of the following precursors are introduced: an organic chemical with amino groups, with amide groups, with imide groups, with hydroxyl groups (water, alcohols, acids, hydroxyl ethylacrylate, etc.), with ether groups, or with ester groups, or an organic precursor such as methane, propane, ethylene, or acetylene. These groups have chemical and physical affinity with the PU powder.

For laser cladding a poly(methyl methacrylate) (PMMA) coating, acrylic groups can be introduced in a functional surface layer onto the polymeric substrate by using an organic precursor comprising acrylic groups (e.g. acrylic acid) so as to ensure compatibility with the acrylic groups of the PMMA material.

As results evident from the aforementioned description, the present invention contemplates the use of any plasma treatment, with or without precursors of any kind, that enhances compatibility of any combination of polymeric materials used in laser cladding. The present invention is hence neither limited to particular plasma forming gasses, nor is it limited to particular precursors for use in the plasma treatment.

In a following step and referring to FIG. 1, the substrate 11 to be coated, and/or the powder that will form the coating, is exposed to the plasma, or to the reactive gas stream resulting therefrom (the afterglow). Procedures of exposing polymers to a plasma are well known in the art and described in literature, such as in “Plasma Physics and Engineering”, by Alexander Fridman and Lawrence A. Kennedy, April 2004 and published by Routledge, USA (ISBN: 978-1-56032-848-3).

The substrate, and/or the powder is brought in contact with the plasma discharge or with its afterglow for a predetermined period of time. A predetermined relative speed between the incident plasma or afterglow and the surface (e.g. speed of the plasma torch relative to the surface) may in addition be selected. Treatment (contact) times may, depending on the application, range between 1 ms and 10 minutes. Particularly suitable treatment speeds may range between 0.00015 m/min and 1000 m/min.

Plasma treatment of powders is known in the art (Martin Karches, Philipp Rudolf von Rohr, ‘Microwave plasma characteristics of a circulating fluidized bed-plasma reactor for coating of powders’, Surface and Coatings Technology, Volumes 142-144, July 2001, Pages 28-33).

Both the substrate and the powder may be exposed to a plasma discharge and/or afterglow. The plasma forming gas may be different or the same for the two materials. For each material, no precursor, a different precursor, or a same precursor may be used. A combination of different precursors may be introduced into a same plasma discharge and/or after glow as well.

During the plasma treatment, the exposed material may be heated to a suitable temperature, in particular in cases wherein a plasma affected zone (treated surface layer) is desired which extends into the depth of the material. Preferably, at least the glass transition temperature and more preferably at least the melting temperature of the polymeric material is reached during plasma treatment. In the alternative, the exposed surface is heated to a temperature below the glass transition temperature of the polymeric material treated.

The heat or the high temperature can enhance the mobility of the polymer chains, which in turn can enhance the formation (grafting) of the functional groups, particularly into the depth of the material.

As a result, an activated volume including the surface (i.e. a surface layer) can be obtained which remains activated even after cooling. Depending on the kind of plasma treatment, treated plastics may be kept for seconds, hours, days, months, or even years without significant degradation of the functionalised zone and thus remain activated during such period. Said period can be influenced by the storage conditions.

As a result of the exposure to the plasma (with or without a precursor), hence, a plasma treated surface layer 14 (or a functionalised zone) is formed, which can be provided with one or more functional (chemical) groups as indicated hereinabove. Such a surface layer, or functionalised zone, is preferably not restricted to only a surface area, but extends into the depth of the plastic material. Such functional groups may be grafted on the polymer chains at the exposed surface of the polymeric material.

The thickness of the (functional) surface layer suitably falls in the range between 1 Å (Angstrom) and 1000 nm, preferably between 3 Å and 500 nm and more preferably between 5 Å and 300 nm.

After plasma treatment, laser cladding can be performed as is known in the art. Firstly, the substrate, which can be plasma treated, is scanned by a laser beam 15 at its—possibly plasma treated—surface. The thermoplastic powder, which can be plasma treated, is introduced by a powder supply means 16, possibly at the location of the incident laser beam, as is illustrated in FIG. 1C. The laser energy may be absorbed by the substrate, the powder or both. This causes the transformation of laser energy into heat. Scanning patterns as are known in the art may be used. The powder may be molten due to direct absorption of laser energy or indirectly due to contact with the heated substrate, or both. The heat causes the powder to melt and spread over the substrate so as to form a coating 17.

In an optional step, the coated substrate may be scanned a second time by the laser beam in order to densify the coating. This may be done in order to ensure that all powder particles melt and that porosity which existed in between powder particles is diminished. Such scanning may be performed by the same laser beam 15.

According to the invention, by the plasma treatment, compatibility is introduced upon the originally incompatible materials such that, upon laser cladding and after cooling, a strong adhesion between the materials (between substrate and coating) is established. The compatible zone can surprisingly extend beyond the surface layer(s) 14 applied by the plasma.

### EXAMPLE 1

### Laser Cladding of a Polyamide Coating on Acrylonitrile Butadiene Rubber (NBR)

Prior to laser cladding, an activation of the substrate is performed using a Plasma-Spot® (VITO, Belgium) apparatus working at atmospheric pressure. A selected gas mixture is ionized in the plasma zone and blown out of the torch. In this way a plasma afterglow is created which is suitable for treatment of different kind of substrate materials and geometries.

A mixture of nitrogen and carbon dioxide was ionized in the Plasma-Spot® in order to generate an active plasma afterglow. The power supply comprises a rectifier with a DC output which is converted to an AC signal with a frequency of 75 kHz. A high voltage is created using a transformer. Dissipated power was set to 10 W/cm² and total flow was kept at 80 standard liter per minute (slm) with a ratio of 72/8 slm N₂/CO₂ using mass flow controllers.

The surface of the NBR substrate was treated at a distance of 4 mm from the Plasma-Spot®. A flat sample was treated at a speed of 8.2 sec per cm².

Laser cladding experiments were carried out with a continuous 150 W diode laser (940 nm wavelength). During a first step, the plastic NBR substrate, which had been subjected to the atmospheric plasma treatment, is heated by scanning the surface with the laser beam. Simultaneously, polyamide powder is blown in the laser beam on the heated surface at a rate of 1.5 g/min by means of argon as a carrier gas with a flow of 10 l/min. The process is controlled by a non-contact optical pyrometer which is continuously measuring the surface temperature at the zone heated by the laser. For the closed loop control, the signal of the actual surface temperature acts as a regulating variable whereas the nominal temperature is used as command variable. According to the mechanism of the PID-controller, both signals are compared and a new output value is calculated from the difference between both values. The laser power is the preferred choice for the controller output because this is the most flexible value (compared to the laser-substrate relative speed).

The polymer powder is partially molten as a result of contact with the laser heated substrate and direct interaction with the laser beam. The laser and the powder delivery move with a velocity of 2000 mm/min and a process step width of 1 mm. For a polyamide powder, the substrate is heated by the laser to a temperature between 180° C. and 400° C., the limits being defined respectively by the melting temperature of the powder and the temperature at which degradation of the powder occurs. A rough layer of 100 μm to 400 μm thick can be obtained. A second laser scanning step, without powder addition, is applied to re-melt this top layer and to decrease the surface roughness and the porosity. The re-melting step is typically performed at a speed of 750 mm/min. The temperature is between 150° C. and 350° C.

Peel testing indicates a better adhesion of the molten polyamide layer to the NBR substrate when atmospheric plasma treatment of the substrate is performed. The average peel strength has increased from 30 N/mm to 350 N/mm.

### EXAMPLE 2

### Laser Cladding of a Polyamide (PA) Coating on a Polypropylene (PP) Substrate

A plasma afterglow at atmospheric pressure is obtained by means of a plasma jet apparatus (PlasmaJet®DC, Raantec, Germany). The plasma-forming gas used was air. The air flow was kept at about 30 l/min (pressure controlled). No precursors were used. The power was 290 Watt. Such a plasma introduces polaric chemical groups onto a PP surface. These polaric chemical groups are compatible with the amide groups of the polyamide.

The PP substrate was hence arranged on an XY-table and exposed the atmospheric plasma afterglow. The PP substrate was kept at a distance of 10 mm from the apparatus during exposure. Treatment speed was 5 m/min.

After the atmospheric plasma treatment, laser cladding experiments are performed under the same conditions as in example 1. A better adhesion of the PA coating to the PP substrate is obtained.

1-14. (canceled)

15. A method of applying a coating of a thermoplastic material on a substrate made of a polymeric material, wherein said thermoplastic material and said polymeric material are incompatible, the method comprising the steps of:
exposing the substrate to a first plasma discharge or the reactive gas stream resulting therefrom to obtain a plasma treated substrate so that one or more chemical groups, which show chemical and/or physical affinity towards bonding to the thermoplastic material, are formed on the plasma treated substrate;
scanning a laser beam along a line on said plasma treated substrate to heat up the plasma treated substrate; and
supplying a powder of said thermoplastic material on said line to form a coating on the plasma treated substrate.

16. A method of applying a coating of a thermoplastic material on a substrate made of a polymeric material, wherein said thermoplastic material and said polymeric material are incompatible, the method comprising the steps of:
exposing a powder of said thermoplastic material to a second plasma discharge or the reactive gas stream resulting therefrom to obtain a plasma treated powder so that one or more chemical groups, which show chemical and/or physical affinity towards bonding to the polymeric material, are formed on the plasma treated powder;
scanning a laser beam along a line on the substrate to heat up the substrate; and
supplying said plasma treated powder on said line to form a coating on the substrate.

17. The method according to claim 15, further comprising exposing a powder of said thermoplastic material to a second plasma discharge or the reactive gas stream resulting therefrom to obtain a plasma treated powder so that one or more chemical groups, which show chemical and/or physical affinity towards bonding to the polymeric material, are formed on the plasma treated powder,

18. The method according to claim 15, wherein the first plasma discharge is formed with a plasma forming gas selected from the group consisting of: air, N₂, O₂, CO₂, H₂, N₂O, He, Ar and mixtures thereof.

19. The method according to claim 15, further comprising the step of introducing a first precursor into the first plasma discharge, or into the reactive gas stream resulting therefrom prior to the exposing step.

20. The method according to claim 16, further comprising the step of introducing a second precursor into the second plasma discharge, or into the reactive gas stream resulting therefrom prior to the exposing step.

21. The method according to claim 19, wherein the first precursor is selected from the group consisting of: allylamine, hydroxyl ethylacrylate, acrylic acid, methane, propane, ethylene acetylene, aminopropyltriethoxysilane and water.

22. The method according to claim 15, wherein the chemical group is selected from the group consisting of: carboxyl, amino, hydroxyl, amide, imide, nitrile, di-imide, isocyanide, carbonate, carbonyl, peroxide, hydroperoxide, imine, azide, ether, ester, siloxane and halogen groups.

23. The method according to claim 15, wherein in the exposing step, a surface zone is affected by the plasma having a thickness falling in the range between 5 Angstrom and 300 nm.

24. The method according to claim 15, further comprising the step of scanning a laser beam along a line on the coating.

25. The method according to claim 15, wherein said polymeric material is a thermoplastic material.

26. The method according to claim 15, wherein said polymeric material is a thermosetting material.

27. The method according to claim 15, wherein in the step of exposing the substrate and/or in the step of exposing the powder, the exposed surface of the exposed material is heated at least temporarily to at least the melting temperature thereof.

28. The method of claim 16, wherein the second plasma discharge is formed with a plasma forming gas selected from the group consisting of: air, N₂, O₂, CO₂, H₂, N₂O, He, Ar and mixtures thereof.

29. The method of claim 20, wherein the second precursor is selected from the group consisting of: allylamine, hydroxyl ethylacrylate, acrylic acid, methane, propane, ethylene acetylene, aminopropyltriethoxysilane and water.

30. The method of claim 16, wherein the chemical group is selected from the group consisting of: carboxyl, amino, hydroxyl, amide, imide, nitrile, di-imide, isocyanide, carbonate, carbonyl, peroxide, hydroperoxide, imine, azide, ether, ester, siloxane and halogen groups.

31. The method of claim 16, wherein in the exposing step, a surface zone is affected by the plasma having a thickness falling in the range between 5 Angstrom and 300 nm.

32. The method of claim 16, further comprising the step of scanning a laser beam along a line on the coating.

33. The method of claim 16, wherein said polymeric material is a thermoplastic material.

34. The method of claim 16, wherein said polymeric material is a thermosetting material.

35. The method of claim 16, wherein in the step of exposing the substrate and/or in the step of exposing the powder, the exposed surface of the exposed material is heated at least temporarily to at least the melting temperature thereof.

36. The method of claim 17, further comprising the steps of introducing a first precursor into the first plasma discharge, or into the reactive gas stream resulting therefrom prior to the exposing step and of introducing a second precursor into the second plasma discharge, or into the reactive gas stream resulting therefrom prior to the exposing step.

37. The method of claim 36, wherein the first and the second precursors are the same.
